(19) United States
(12) Patent Application Publication
(10) Pub. No.: US 2014/0362738 A1
(43) Pub. Date: Dec. 11, 2014

(54) VOICE CONVERSATION ANALYSIS UTILISING KEYWORDS

(71) Applicants: John Eugene Neystadt, Ra'Anana (IL); Diego Urdiales Delgado, Madrid (ES)

(72) Inventors: John Eugene Neystadt, Ra'Anana (IL); Diego Urdiales Delgado, Madrid (ES)

(73) Assignees: TELEFONICA SA, Madrid (ES); TELEFONICA DIGITAL LTD, Ra'Anana (IL)

(21) Appl. No.: 14/119,747

(22) PCT Filed: May 25, 2012
(86) PCT No.: PCT/EP2012/059832

§ 371 Date: Apr. 28, 2014

(30) Foreign Application Priority Data
May 26, 2011 (ES) P201130858

(51) Int. Cl. H04M 3/42; G10L 15/08; G10L 15/26; H04W 4/16

(52) U.S. Cl. CPC H04M 3/42221; H04W 4/16; G10L 15/08; G10L 15/265; G10L 2015/088
USPC 370/259; 455/414.1; 704/251; 704/235

(57) ABSTRACT

A system and a method for analyzing the content of a voice conversation. In particular a system for analyzing the content of a voice conversation, comprising a communication block which establishes and manages the communication session between the parties of said conversation; a keyword module in communication with a plurality of information sources for obtaining and storing keywords relevant to the parties; and an extraction block which extracts at least part of said conversation based at least in part on keywords stored in the keyword module and related to the parties.

### FIELD OF THE ART

The present invention generally relates, in a first aspect, to a system for analyzing the content of a voice conversation, and more particularly to a system which comprises extracting the details of said conversation by means of an extraction block and presenting the results of said extraction to at least one of said parties during said voice conversation.

A second aspect of the invention relates to a method arranged for carrying out the extraction of said voice conversation and the presentation of the results of said extraction.

### PRIOR STATE OF THE ART

Currently, the only information generally available to the parties who are carrying out a voice conversation (typically, a phone call) is the identity of the parties, possibly including the devices used by them to connect to the conversation (mobile phone, fixed phone, etc.) and the duration of the conversation so far. Information of the content of the conversation, which could be useful to support the conversation, is not available. There is no automated way for the parties to recall any of the previous content of the conversation while it is still active (i.e., during the call). It is also cumbersome to review the contents of the conversation after it has ended.

In order to have access to information previously discussed in the voice conversation while the conversation is on-going, it is possible to take manual notes during the conversation. Also, some voice call services offer an integrated chat service which can also be used to manually reflect some pieces of the content of the conversation in a way that they are visible to all parties in the conversation.

In order to review the contents of the conversation after it has ended, it is possible to review the manual notes. It is also possible to use any of the available call recording services to record the call, so that its contents are available after it has ended.

There are some developments in speech processing which have been targeted to the identification of specific details in the speech, such as [1]. Also, word spotting technologies, such as those described in [2], offer more advanced functionality, allowing the identification of specific words or simple patterns uttered in speech.

Finally, a patented method described in [3] is useful for attaching annotations to a database containing voice call information.

Problems with Existing Solutions

A manual approach to recalling the content of a conversation has some important drawbacks. Taking manual notes during the conversation disrupts the conversation, often causing pauses in the speech while one of the parties writes or types. In addition, in general notes are not visible to all parties, therefore benefiting only the party that takes them. Nevertheless, if notes are taken, they are useful to keep track of the contents of the conversation after it has finished.

Using the associated chat channel to manually reflect details of the content of the conversation has the same disadvantage of disrupting the flow of the conversation, although it has the advantage of making those details visible to all parties in the conversation.

Neither of the manual methods is well suited for conversations on the move.

Recording the conversation allows the parties to recover information after the call has ended. However, recorded information is virtually impossible to use during the call (before the call ends). In addition, it is cumbersome to search for specific details in the recorded audio. Finally, the recording may not be automatically available to all parties, instead requiring the recorder to manually share the recorded audio with all the parties in the conversation after it ends.

Current solutions based on speech processing do not fully address the problem of supporting the on-going conversation.

The technology described in [1] could be used to automatically create basic annotations of the content of the conversation (specifically, alphanumeric sequences, such as phone numbers or spelled out words). These basic annotations can be a first step towards supporting voice conversations. Nevertheless, [1] does not describe any mechanism in which these annotations could be made available to the parties during the call.

[2] presents a mechanism to obtain more meaningful annotations (words or simple patterns) from audio processing. Again, these techniques can be used to extract information, but no indication is given as to how that information can be presented to the users during the call.

Finally, [3] focuses on the method to link call annotations (i.e. information about the content of a call, without specifying how this information is obtained) to the record corresponding to the call in a call log database. This method can be used to perform the link in the back end, but no indication is given of how the annotations can reach the parties during the call.

### DESCRIPTION OF THE INVENTION

It is necessary to offer an alternative to the state of the art which covers the gaps found therein, particularly related to the lack of proposals which really allow presenting the results of the extraction of a voice conversation in real time or near real time.

To that end, the present invention provides, in a first aspect, a system for analyzing the content of a voice conversation, comprising:

a) a communication block which establishes and manages the communication session between the parties of said conversation; and

b) an extraction block which extracts at least part of said conversation;

On contrary to the known proposals, the system of the invention, in a characteristic manner it further comprises, performing said extraction during the voice conversation and delivering, directly or via at least one intermediate entity, and displaying the results of said extraction to at least one of the parties during said voice conversation.

Other embodiments of the method of the first aspect of the invention are described according to appended claims 2 to 13, and in a subsequent section related to the detailed description of several embodiments.

A second aspect of the present invention comprises a method for analyzing the content of a voice conversation, comprising:

a) establishing a communication session between the parties of said voice conversation; and

b) extracting at least part of said conversation in order to analyze its content.
On contrary to the known proposals, in the method of the invention, in a characteristic manner, said extraction of step b) is performed during said voice conversation and wherein the method further comprises presenting the results of said extraction to at least one of said parties during said voice conversation.

### BRIEF DESCRIPTION OF THE DRAWINGS

The previous and other advantages and features will be more fully understood from the following detailed description of embodiments, with reference to the attached drawings, which must be considered in an illustrative and non-limiting manner, in which:

FIG. 1 shows a general scheme of the proposed system of the present invention.

FIG. 2 shows, according to an embodiment of the system proposed in the invention, the general scheme of the system when the voice conversation is performed via a VoIP call.

FIG. 3 shows, according to an embodiment of the system proposed in the invention, the architecture of the detail extraction module.

FIG. 4 shows, according to an embodiment of the system proposed in the invention, the general scheme of the system when the voice conversation is performed via regular PSTN/PLMN phone call.

FIG. 5 shows, according to an embodiment of the system proposed in the invention, the general scheme of the system when the voice conversation is performed in a convergent network and one of the parties is a PSTN/PLMN phone client and the other party is a VoIP client.

FIG. 6 shows a schematic block diagram of a voice analysis system.

### DETAILED DESCRIPTION OF SEVERAL EMBODIMENTS

The invention consists of a system which analyses the content of a voice conversation and presents details extracted from the content to the parties during the conversation.

Next, the technical details of the present invention will be described according to FIG. 1:

The parties in the conversation (for simplicity, a two-party conversation has been depicted in the figure) use Clients to communicate (11 is the Client used by the caller, 12 is the Client used by the callee). Typically, these clients would be native to the device operating system, in charge of managing the establishment, maintenance and termination of the voice session. In the proposed system, Clients have the additional function of receiving and displaying details extracted from the content of the conversation.

In addition to the clients, a Communication manager module is present (13). This module is in charge of establishing the communication sessions between the clients (i.e. the voice conversation); it establishes the audio session with the Detail extraction process; and it also ensures that the details generated by the Detail extraction module reach the clients.

The Detail extraction module takes one or several audio inputs and processes them in order to extract the relevant details to be presented to the parties in the conversation. In order to extract those details, it may apply a combination of several techniques: word spotting, by which the Detail extraction module is configured with a list of words or patterns to be detected; and transcription, by which audio is transcribed to text, which is then processed to obtain keywords or details.

When the caller wishes to initiate the conversation, the Caller client communicates with the Communication manager to establish the voice conversation (111). This can be done using any of the standard session management protocols, such as SIP or SS7. The Communication manager communicates in turn with the Callee client (131) to establish the voice conversation.

The voice conversation is composed of a multidirectional (in the case of multiple parties) or bidirectional (in the depicted case, where there are two parties in the conversation) flow of audio from each client to the rest. In the figure, the audio originating from the Caller client is labelled Audio flow A (112), whereas the audio originating from the Callee client is labelled Audio flow B (121).

Once the voice session between the Clients has been established, the Communication manager ensures that the audio flow from the Caller client reaches the Callee client (132) and that the audio flow from the Callee client reaches the Caller client (133). In addition, it sets up a processing session with the Detail extraction module (134) and duplicates the audio flows, sending a copy of the audio flow from the Caller and the audio flow from the Callee to the Detail extraction module (135) (136).

The Detail extraction module processes the audio and generates the Details (141), which it sends to the Communication manager. The Communication manager then forwards those Details to the Clients to be displayed to the parties in the conversation.

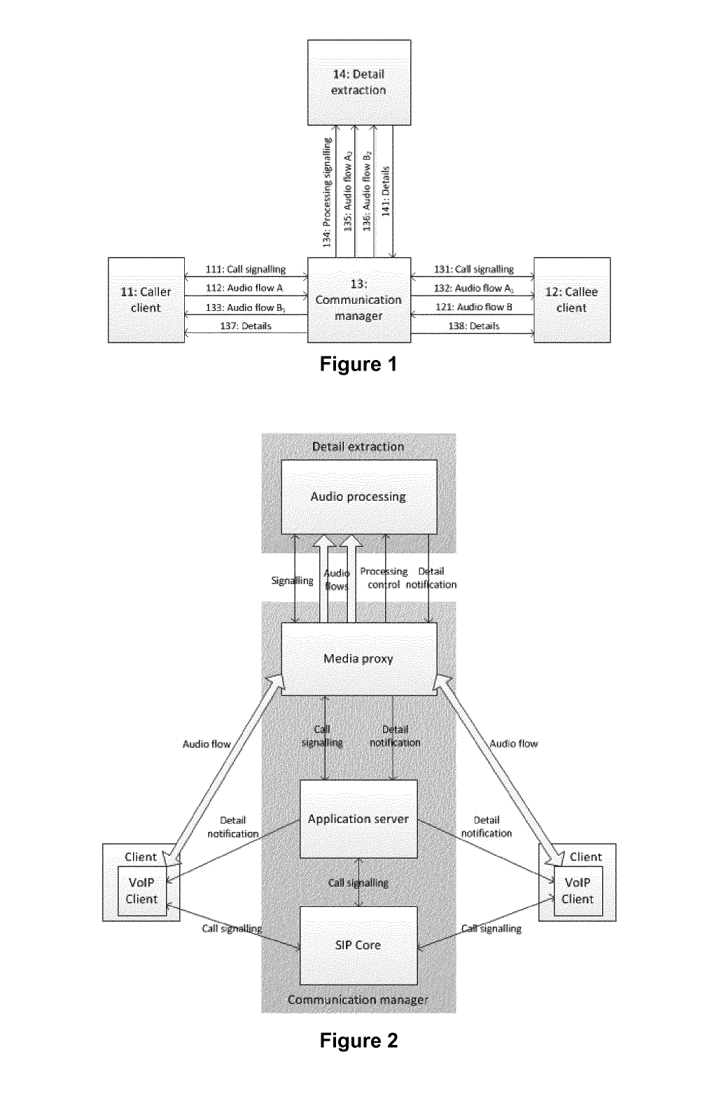

In a preferred embodiment of the present invention, as shown in FIG. 2:

Clients are mobile applications, which include presentation logic to display the details, and a Voice over IP (VoIP) stack to manage the voice calls and receive the detail notifications.

The voice call is a VoIP call, established using SIP.

The Communication manager comprises:
A SIP core, in charge of client registration and receiving call initiation requests
The SIP core forwards call initiation requests to the Application server
The Application server makes sure the call is established between the clients through the Media server.
The Media proxy establishes the processing session with the Audio processing module, duplicates the audio flows and controls the processing.

The Detail extraction module resides in a server in the network.

The Detail extraction module processes each audio flow separately. It duplicates the flows internally as many times as needed to do parallel processing, correlating the results from the different processing threads to obtain the details.

Details are output by the Detail extraction module and forwarded by the Media server to the Application server. The Application server optionally filters, modifies or enriches the Details before sending them as notifications to the Clients. Notifications will be sent to the Clients directly by the Application server, as depicted in the figure, or through the SIP core.

A possible embodiment of the Detail extraction (Audio processing) module, as shows in FIG. 3, is described next:

The acquisition of the audio and the control of the processing are done through an MRCP server.

The audio input arrow represents both audio channels, but each channel is processed independently.

The audio processing occurs in two separate streams, for each audio channel:
A word spotting stream uses word spotting to identify specific words (out of a predefined list), patterns and simple grammars, which it returns as details.
A transcription stream uses audio transcription (speech-to-text) to produce a textual stream which is a transcription of the streamed audio, and then performs text analysis to look for specific words, patterns, grammars or rules in the text.

Details obtained through any of the two methods are then aggregated and returned as replies by the MRCP server.

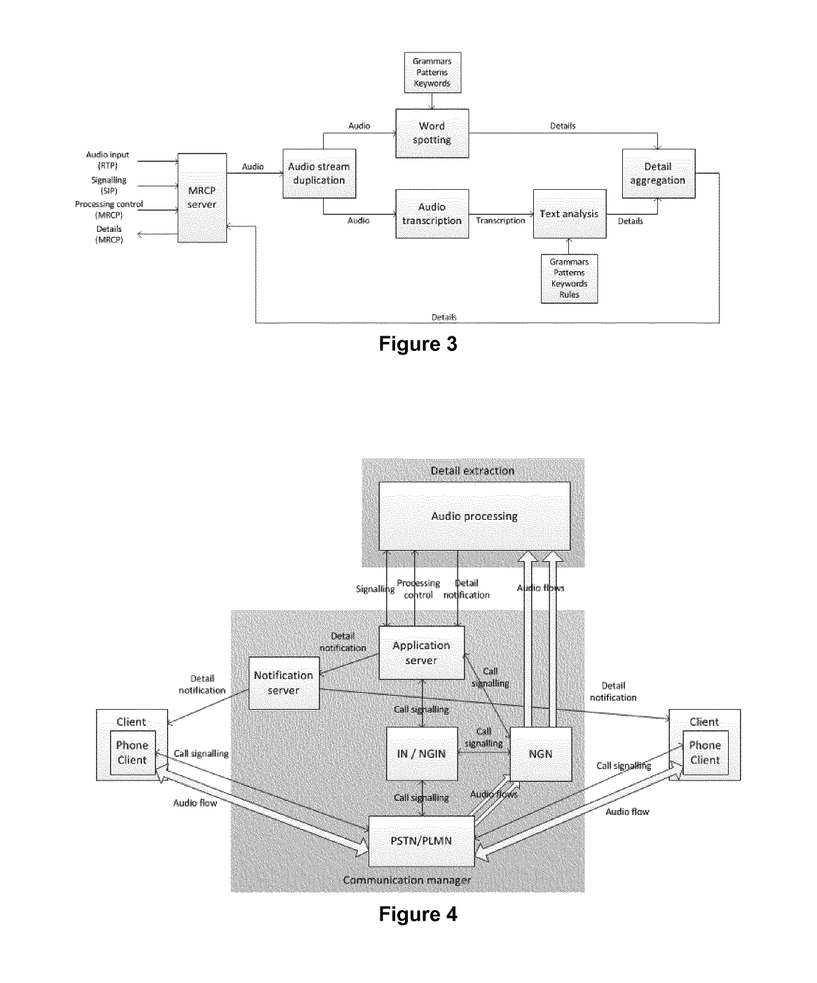

An additional embodiment of the present invention, as shown in FIG. 4, is targeted to support regular PSTN/PLMN phone calls:

Clients embed a legacy phone client and phone calls are regular PSTN/PLMN phone calls.

The Communication Manager comprises modules in the PSTN/PLMN, the IN/NGIN, the NGN, plus an Application server and a Notification server.

The PSTN/PLMN notifies the IN/NGIN when a call is made. The IN/NGIN in turn notifies the Application server, which demands the IN/NGIN to create two new call legs to the Audio processing module. This is done through the NGN. The Application server notifies the Audio processing module of the incoming audio flows.

The Detail extraction module receives and processes the flows. It generates details which it sends to the Application server.

The Application server optionally filters, modifies or enriches the Details before sending them as notifications to the Clients. Notifications will be sent to the Clients through a Notification server.

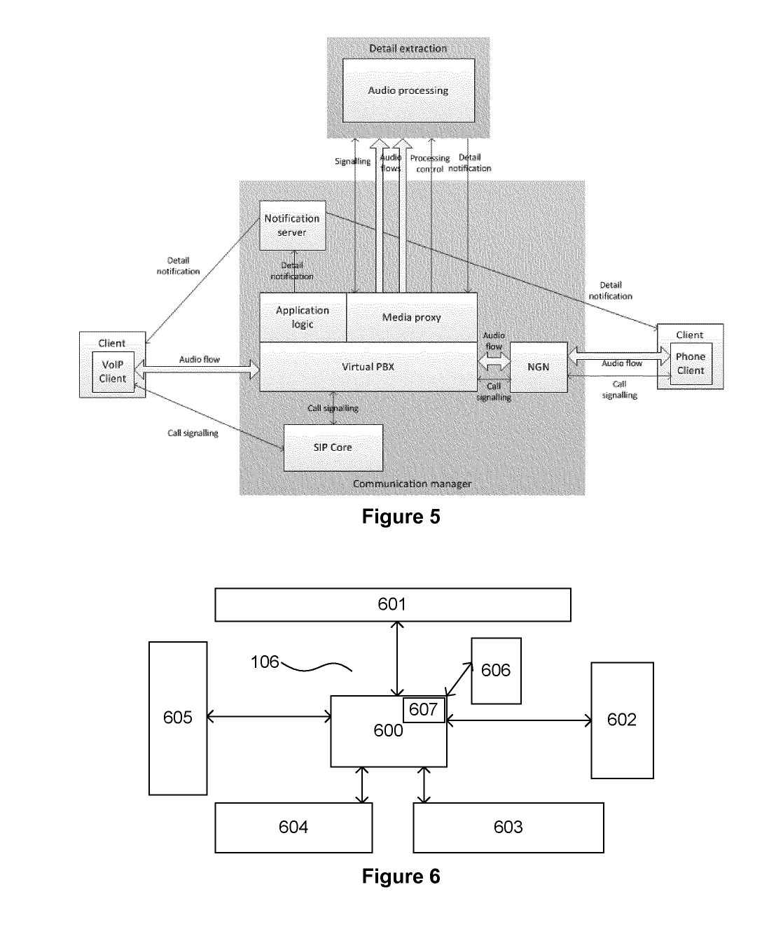

An additional embodiment of the present invention, as shown in FIG. 5, is targeted for convergent networks, i.e. those that support traditional PSTN/PLMN phone clients alongside VoIP clients. This embodiment uses a virtual PBX to communicate legacy phone clients and IP clients:

Clients can either embed a legacy phone client or a VoIP client.

The Communication Manager comprises
A SIP core in charge of the registration of VoIP clients and establishing the call legs to and from those clients.
A Virtual PBX, which is able to establish voice calls between legacy and VoIP clients, by connecting to the NGN.
An Application logic and a Media proxy, typically implemented as plugins to the Virtual PBX. The Media proxy establishes the processing session with the Audio processing module, duplicates the audio flows, controls the processing and receives the Details. The Application server optionally filters, modifies or enriches the Details before sending them as notifications to the Clients. Notifications will be sent to the Clients through a Notification server.

The Detail extraction module receives and processes the flows. It generates details which it sends to the Application server.

Advantages of the Invention:

The proposed system supports voice conversations by singling out relevant details extracted from the content of the conversation, in a way that:

is automated, so that no user intervention is required;

is non-disruptive, as a consequence of its automation, not requiring the parties in the conversation to interrupt the conversation flow; and

allows relevant information to be visible during the call, without having to wait for the call to end.

The details from the conversation presented to the parties allow them to directly see specific details which should be remembered, such as numbers or addresses, avoiding possible noting errors which may happen when one party takes manual notes. In addition, they are useful when any of the parties is not able to take manual notes of relevant details, for instance because the person is on the move, driving or has no noting material at hand.

The proposed system effectively constitutes an auxiliary sub-channel attached to the voice conversation, where relevant details get added and are available both during the call and after it.

In addition, the automated detection of relevant details turns those details into actionable items (such as a place name or a date which can easily be added as an appointment in a calendar application).

The accuracy of voice-to-text systems, such as those utilised in the system described hereinbefore, may be improved if they are provided with known keywords which may be expected to be found in the voice media. The accuracy of transcription for those keywords may be particularly improved, and the general accuracy may also be increased. The accuracy of the systems described hereinbefore may therefore be improved by the supply of keyword lists to the detail extraction module.

FIG. 6 shows a schematic block diagram of a system for supplying keywords to a detail extraction module to assist in the transcription of voice signals to text. Extraction module 600 is in communication with a number of data sources 601-605 from which keywords may be extracted. Extraction module 600 is also in communication with a keyword store 606.

Keyword store 606 stores keywords that may be relevant to particular users. In an embodiment a database of users and keywords may be maintained at keyword store 606. Keyword store 606 is maintained by a keyword process 607 at extraction engine 606. Keyword process 607 is shown within the extraction engine 606, but the process may also be implemented as a separate system with communication to the keyword store 606 and the extraction engine 600 as required. In certain implementations the keyword process 607 is in communication with data sources 601-605 rather than the extraction engine 600 being in communication with them.

Keyword process 607 utilises data sources 601-605 to maintain a list of keywords in keyword store 606 relevant to subscribers to the service. Those keywords are extracted from the various data sources 601-605 according to the following principles. Keywords may be extracted, for example, automatically at intervals, when there is an indication the data sources have changed, or when the extraction module 600 is utilised for a call.

The keyword store 606 may be updated by the addition of new words identified by keyword process 607. Keyword process may also maintain existing data for example by the removal of words after a defined interval or when conditions are met. For example, keywords may be removed from the keyword list when they no longer appear in any of the data sources 601-605.

Extraction module 600 is in communication with one or more social networks 601. During a configuration stage extraction engine 600 is provided with a subscribers credentials to allow access to that subscribers data within social networks 601. Extraction module 600, and specifically keyword process 607, may then access the social networks which have been configured for access, and obtain data which are utilised as keywords. A range of aspects of the social networks may contain keywords that are relevant to likely speech for the subscriber, for example names of people the subscriber contacts or is linked to, locations or places mentioned in relation to the user or where they have ‘checked in’, events subscribers are linked to, general information in the user's profile, groups the user is a member of, and descriptions and addresses of pages the subscriber has expressed an interest in. As will be appreciated any aspect of data related to a subscriber may form the basis of relevant keywords and this list is not exhaustive or restrictive.

Extraction module 600 is also in communication with contact information system 602. Contact information system 602 may comprise a user's contact list in a communication device being used to make calls, and also contact lists in computers or systems also used by the user. During a configuration stage extraction engine 600 is provided with access to the contact information systems 602 such that data can be obtained, as described above in relation to social networks 601. Names, addresses, and other data related to stored contacts may be utilised as the basis of keyword lists.

Extraction module 600 is also in communication with communication archive 603. Communication archive 603 may comprise archives of communications such as emails and instant messages. As described hereinbefore extraction module 600 is provided with access to the communication archives 603 such that data can be extracted. Data such as the subject, content, and destination of messages in the communication archives 603 may provide relevant keywords.

Extraction module 600 is also in communication with business information systems 604. For example the information systems 604 may comprise enterprise directories (for example LDAP directories and similar), intranet information stores, databases, and internet sites. As described above, extraction module 600 is provided with access to the information systems 604 during configuration. Data such as employee names, departments, projects, customers, and partners may be extracted and form the basis of keyword lists.

Extraction module 600 is also in communication with public information sources 605. Public information sources may comprise search engines, public information provided by social networks, and information sites such as news providers and entertainment lists. Such information sources may provide indications of currently popular topics which are more likely to be discussed in conversation and therefore may present keywords for extraction engine 600.

The set of data sources described herein are provided as examples only and are not restrictive. Different data sources may be utilised according to the principles described herein in various combinations. The data sources may not be treated independently of one another, but the data may be combined and compared to obtain more relevant keywords.

The system described hereinbefore thus allows the automated collection of keywords relevant to subscribers. Those keywords may then be utilised by the extraction module to analyse calls. The keywords may be utilised in word-spotting algorithms, or in other forms of voice analysis, to improve the accuracy and/or relevancy of the output.

A person skilled in the art could introduce changes and modifications in the embodiments described without departing from the scope of the invention as it is defined in the attached claims.

Acronyms

IN Intelligent Network

IP Internet Protocol

MRCP Media Resource Control Protocol

NGIN Next Generation Intelligent Network

NGN Next Generation Networking

PBX Private Branch Exchange

PSTN Public Switched Telephone Network

PLMN Public Land Mobile Network

SIP Session Initiation Protocol

VoIP Voice over IP

### REFERENCES

[1] Create automated verbal conversation annotations for phone numbers, acronyms, and other spoken words, http://www.ibm.com/developerworks/opensource/library/os-sphinxspeechrec/index.html

[2] Broadcast speech recognition system for keyword monitoring, U.S. Pat. No. 6,332,120

[3] U.S. Pat. No. 5,241,586 Voice and text annotation of a call log database, U.S. Pat. No. 5,241,586

1-30. (canceled)

31. A system for analyzing the content of a voice conversation, comprising:
a) a communication block which establishes and manages the communication session between the parties of said conversation;
b) a keyword module in communication with at least one information source for obtaining and storing keywords relevant to the parties,
wherein the keyword module obtains keywords from the at least one information source prior to the communication session being established, the at least one information source comprising at least one of: a social network, a contact information system, a communication archive, a business information system, and a public information system, in which:
the keywords obtained from the social network are extracted from at least one of: a name of one of the relevant parties' contacts, a location or place mentioned in relation to the relevant party, an event the relevant party is linked to, a group the relevant party is a member of, and the description and address of a page the relevant party has expressed an interest in;
the keywords obtained from the contact information system are extracted from data related to stored contacts;
the keywords obtained from the communication archive are extracted from at least one of the subject, the content, and the destination of messages in the communication archive;
the keywords obtained from the business information system are extracted from at least one of: the names of: employees, departments, projects, customers, and partners; and
the keywords obtained from the public information sources are extracted from currently popular topics in such sources; and
c) an extraction block which extracts at least part of said conversation based at least in part on keywords stored in the keyword module and related to the parties.

32. A system as per claim 31, wherein said extraction block operates during said voice conversation and is arranged for delivering, directly or via at least one intermediate entity, the results of said extraction to at least one of said parties during said voice conversation.

33. A system as per claim 31, wherein the keyword module maintains a store keywords relating to subscribers to the service provided by the system.

34. A system as per claim 33, wherein the keyword modules obtains keywords from content or accounts at the information sources related to corresponding subscribers.

35. A system as per claim 31, wherein said extraction block comprises a word-spotting algorithm utilising keywords stored at the keyword.

36. A system as per claim 31, wherein said communication block further establishes and manages the communication with the extraction block and sends the results of said extraction performed in said extraction block to at least one of said parties.

37. A system as per claim 31, wherein said extraction block extracts part of the conversation by duplicating, at least once, the audio flow generated by each of said parties and correlating the results from different processing threads.

38. A system as per claim 37, wherein said processing threads consist of at least one word spotting thread and one thread of transcription of audio to text followed by analysis of said text.

39. A system as per claim 31, wherein said extraction block resides in a server of a network and it further comprises a Media Resource Control Protocol, or MRCP, server to acquire the audio inputs and to output the results of said extraction.

40. A system as per claim 31, wherein said voice conversation is a VoIP call and said standard session management protocol is Session Initiation Protocol, or SIP.

41. A system as per claim 31, wherein said communication block further comprises:
a) a SIP core which performs at least the registration of each of said parties and the reception of call initiation requests;
b) a media proxy which establishes a communication session with the extraction module and with each of said parties; and
c) an application server which controls the communication between said media proxy and said parties.

42. A system as per claim 31, wherein said communication block further comprises a notification server which sends the results of said extraction to at least one of said parties, and an application server which sends the audio inputs to said extraction block and the result of said extraction to said communication block.

43. A method for analyzing the content of a voice conversation, comprising:
a) establishing a communication session between the parties of said voice conversation; and
b) extracting at least part of said conversation in order to analyze its content; wherein the extraction is performed at least in part based on a list of keywords relevant to the parties, wherein the keywords are obtained automatically from information sources.

44. A system for analyzing the content of a voice conversation, comprising:
a) a communication block which establishes and manages the communication session between the parties of said conversation; and
b) an extraction block which extracts at least part of said conversation; wherein the system is characterised in that said extraction block operates during said voice conversation and is arranged for showing, directly or via at least one intermediate entity, the results of said extraction to at least one of said parties during said voice conversation.

45. A system as per claim 44, wherein said communication block makes use of standard session management protocols to establish said voice conversation between said parties.

46. A system as per claim 45, wherein said intermediate entity is said communication block.

47. A system as per claim 46, wherein said communication block further establishes and manages the communication with the extraction block and sends the results of said extraction performed in said extraction block to at least one of said parties.

48. A system as per claim 44, wherein said extraction block extracts part of the conversation by duplicating, at least once, the audio flow generated by each of said parties and correlating the results from different processing threads.

49. A system as per claim 48, wherein said processing threads consist of at least one word spotting thread and one thread of transcription of audio to text followed by analysis of said text.

50. A system as per claim 44, wherein said extraction block resides in a server of a network and it further comprises a Media Resource Control Protocol, or MRCP, server to acquire the audio inputs and to output the results of said extraction.

51. A system as per claim 44, wherein said voice conversation is a VoIP call and said standard session management protocol is Session Initiation Protocol, or SIP.

52. A system as per claim 51, wherein said communication block further comprises:
a) a SIP core which performs at least the registration of each of said parties and the reception of call initiation requests;
b) a media proxy which establishes a communication session with the extraction module and with each of said parties; and
c) an application server which controls the communication between said media proxy and said parties.

53. A system as per claim 44, wherein said voice conversation is performed via regular Public Switched Telephone Network or Public Land Mobile Network phone calls.

54. A system as per claim 53, wherein said communication block further comprises a notification server which sends the results of said extraction to at least one of said parties, and an application server which sends the audio inputs to said extraction block and the result of said extraction to said communication block.

55. A system as per claim 31, wherein said voice conversation is performed via a convergent network which supports traditional phone means alongside IP means.

56. A system as per claim 55, wherein said communication block further comprises a virtual Private Branch Exchange which establishes and manages the communication between traditional phone users with VoIP users.

57. A method for analyzing the content of a voice conversation, comprising:
a) establishing a communication session between the parties of said voice conversation; and
b) extracting at least part of said conversation in order to analyze its content; wherein the method is characterised in that said extraction of step b) is performed during said voice conversation and wherein the method further comprises presenting the results of said extraction to at least one of said parties during said voice conversation.

58. A method as per claim 57, wherein said extraction comprises at least combining word spotting techniques and the transcription of audio to text followed by analysis of the text.
